(19) United States
(12) Patent Application Publication
(10) Pub. No.: US 2002/0112027 A1
(43) Pub. Date: Aug. 15, 2002

(54) Method of providing user-related information between devices on a data network

(76) Inventors: Adrian J McHugh, Knocknacarra (IE); Tommy Morris, Athenry (IE); Martin Sweeney, Tuam (IE); Michael Healy, Castlegar (IE)

Correspondence Address: Lee, Mann, Smith, McWilliams, Sweeney & Ohlson, P.O. Box 2786, Chicago, IL, 60690-2786, US

(21) Appl. No.: 09/740,200

(22) Filed: Dec. 18, 2000

(51) Int. Cl. G06F 15/16

(52) U.S. Cl. 709/218; 709/219

(57) ABSTRACT

A method of passing data relating to a user between first and second devices on a network, in which the first device automatically retrieves data relating to the user from a file in which the data is held as a plurality of data items identified by data item identifiers. The first device receives a request from the second device and the request identifies one or more pre-defined data items. The first device then retrieves the requested items and forwards these to the second device. The invention has particular application in completing frequently requested information in a web page, with the data being held on the user's own PC or on a remote data server.

### FIELD OF THE INVENTION

This invention relates to the provision of user-related data between devices over a data network. The invention has particular application in the provision by a user of personal data to an application running on a remote computer.

### BACKGROUND OF THE INVENTION

For commercial transactions conducted over data networks such as the Internet, particularly in web-based transactions, it is frequently necessary for a user to provide personal information and transaction-related information (such as credit card details) to the organisation with whom a transaction is being conducted.

Typically, a user will access a web site posted by the organisation with whom the transaction is being conducted (referred to for simplicity as the “retailer”). When making a purchase, the user is presented with a form containing various fields (such as first name, last name, various address fields, credit card number and expiry date). The user fills in the requested information and submits the form. The application hosting the website captures the information from the various fields and uses this information to process the order and bill the customer. This process is tedious for the user and can result in errors being generated.

An additional problem with this method of conducting transactions is that the user may not necessarily have all of the required information to hand. Even if the information is stored on the user's computer, the user may wish to conduct the transactions from a shared computer, or from a computer which the user has never before used (such as a computer in an “Internet cafe”).

These difficulties are not limited to users of personal computers, since facilities exist for users to conduct network-based transactions from other network devices such as mobile telephones (including WAP phones) and personal digital assistants (PDAs).

Furthermore, the problems are not confined specifically to commercial transactions involving payments made by users. The same difficulties in filling in form fields are encountered in many situations by Internet users, such as when registering with providers of various services and information, and when submitting requests for information.

Additional difficulties may arise for users who are conducting transactions on behalf of their employer or their company, since in such cases, it is necessary for the individual user to have the requisite corporate information, including financial and billing information requested by the retailer, readily to hand, and user's are less likely to know the user details of their employer than their own personal details.

Parallel problems are encountered when the user is not connected directly to the web site over the Internet. For example, individuals who wish to purchase commodities (e.g. tickets) by telephone are often required to dictate the relevant details to an operator who then performs the data entry task into an application hosted by the retailer. Similarly, in situations such as a guest checking into a hotel, the guest will either dictate his or her details to the hotel receptionist, or will manually fill in a form, following which the receptionist enters the details into the hotel check-in system. This type of data entry is even more problematic, as language difficulties may arise, and because the user has no direct control over the information being submitted.

The disadvantages outlined above can lead to increased costs and delays for all parties involved in transactions, and can also mitigate against the attractiveness of conducting transactions using the methods outlined.

The present invention has as an object the provision of improved methods of providing user-related information to third party computer applications, and the provision of improved systems and computer programs for use in the above situations.

### SUMMARY OF THE INVENTION

The invention provides a method of transferring data relating to a user between two data processing devices over a communications network. The method involves the following steps:

a) the first device receives a request for data from the second device, with the request identifying one or more pre-defined data elements (e.g. name, address, credit card number) which the second device requires;

b) the first device accesses a file containing data relating to the user. The data in the file includes a number of data elements identified by identifiers, and the first device retrieves one or more of the data elements identified in the request; and

c) the first device forwards the retrieved data elements to the second device.

The method of the invention enables the user to store the commonly requested data elements in a single location, and to allow the device (e.g. a personal computer, mobile phone, PDA, or a web server of a trusted third party) to handle requests for data automatically, identifying the particular items requested, retrieving the items, and sending them on to the requesting party. This eliminates the time involved in repeatedly entering the same data into a number of different web sites or other data entry systems, and also eliminates the potential for mistakes in typing or transcription of words or numbers.

Preferably, one or both of the two devices mentioned above are computers, but they can be any suitable data processing devices connected to one another on a data network.

In one embodiment, the file is stored on the first device. It could however be stored elsewhere provided the first device has access to it.

In one particularly useful application of the invention, the request is in the form of a web page having one or more fields for receiving data elements, and the identification of the pre-defined data elements is in the form of machine-readable tags accompanying the one or more fields.

Thus, the computer code which is passes from a web site to a user's PC, allowing the user's PC to display a web page, could include additional identifiers, such as the code “<firstname>” beside a field where the user inserts his or her first name. This allows the user's PC to identify the nature of the data item to be inserted, and therefore tells the PC that this item is to be retrieved from the file containing the user's details. Alternatively, the PC browser might be set up with the intelligence to deduce from the wording of the page which the user sees, that the user's first name is required at a particular point (in the same way that humans can identify that their first name is required on a form even though the form may have different ways of indicating that this is the data required).

Preferably, if tags are included in the request, the first device retrieves from the data file those data elements having identifiers which correspond to the tags in the request. The tags in the request and identifiers in the file need not be identical, provided that the device can correlate the information stored with that requested.

The invention is advantageously implemented by a browser engine operating on the first device which adds the retrieved data elements to the web page and presents the web page including the added data elements to a user before forwarding the data elements to said second device. In other words, it is envisaged that the browser engine (the software providing the functionality of a web browser) will not only retrieve the data requested but will also fill in the form and send the data in the same way as if the user had typed the data on screen.

The browser engine preferably provides the user with the option to confirm the submission of the data before forwarding the data to the second device.

The browser engine will preferably also provide the user with the option to vary the data elements before forwarding the data elements to the second device. This might be useful if the user wants to provide a different e-mail address to different companies.

The first device may log the submission of the data elements to the second device, to keep track of which parties have been given which data.

This feature allows the browser to update the data held by particular sites if the user changes some of the stored data. For example, if the user were to move house, the browser could notify the new address to any sites which had stored the old address (as could be determined from the log). This could be done automatically after the details are changed, or upon the next visit to the site. The user could veto particular sites from obtaining changes of details also, such as to prevent a new email address from obtaining junk e-mail or “spam”.

In an alternative embodiment, the first device is a server which stores the data on behalf of the user. Thus, a single “data provider” might store details for many users, and handle all data requests relating to those users. This is particularly useful in that it does not tie the user to using his or her own machine, since interested parties looking for data can be directed by the user to the data provider from any machine, e.g. if the user is in an Internet cafe and wishes to purchase goods over the Internet.

Normally, it will be desirable, for added security in such cases, for an additional step of verifying with the user that the data should be forwarded to the second device.

The user may be connected to the network by a device which is physically remote from the first device. Thus, the data server (first device) could be in a different country, and the user could connect to the Internet from a new location, or using a different type of device to that normally used (a WAP phone rather than a desktop PC for example).

Suitably, in such cases, the user uses a third device to access a web page hosted by the second device (web server), and the user directs the second device to forward its data request to the data server in order to supply the information requested on the web page.

This can be done by the user providing the second device with the network address of the first device. A URL or an IP address could be used.

Preferably, the data server generates a verification request to the user in response to the data request being received from the second device.

This verification request could be conducted using a different channel. For example, a user in an Internet cafe might receive an SMS text message on his or her mobile phone from the data server, to which he or she must respond before the data is released to the requesting (second) device.

Preferably, however, the user is connected to the network by a third data processing device, and the verification request is passed from the data server to the user's networked device via the web server or other second device.

Thus, a user accessing an on-line ticket seller from an Internet cafe might direct the seller to the data server's web address for the data to be supplied. The data server in response sends to the user, via the seller, a request for verification (e.g. to input a PIN), and only a successful response by the user to the seller (and from there to the data server) would enable the release of data.

In an alternative scenario, the user may be based at the second device and the verification is accomplished by means of an interaction between the user and the second device.

Thus, the user need not be on-line at all. For example, the user could supply a hotel receptionist with access to the necessary data to check in to the hotel, by directing the receptionist's PC to the data server, and verifying his or her identity on the hotel PC.

Preferably, the user interacts with the second device at least partially by means of an ID device held by the user and an ID device reader connected to said second device.

The ID device may be selected from a magnetically readable data carrier, an optically readable data carrier, a carrier containing an integrated circuit on which an identification is stored, a device operable to transmit electromagnetic signals to an ID device reader, and a mechanically readable data carrier.

The ID device may carry a network address of the first device in machine readable format.

The ID device could also or instead carry a network address of the first device in human readable format.

The ID carrier can contain information effective to identify the user to the first machine. Thus, a magnetic strip on a card held by the user might encode a URL for the data server, and an ID number or username relating to the individual user.

In a further aspect the invention provides a computer program product which causes a computer (or other device) to transfer data relating to a user over a communications network by:

a) receiving over the network a request for the data, the request including an identification of one or more pre-defined data elements for which the request is made;

b) accessing a file containing data relating to the user, the file including identified data elements and retrieving from the file one or more of the data elements identified in the request; and

c) forwarding over the data network to another computing device the retrieved data elements.

The program preferably further includes instructions to implement a web browser having this enhanced capability. However, it could simply be a “plug-in” or an upgrade for an existing browser, or it might run independently of a browser (e.g. on a data server or PDA).

If in the form of a browser, the request can be in the form of a web page having data entry fields and the browser can then identify the data elements required for the fields from tags included in the web page.

For data server programs, the instructions may be further effective to cause the server to identify the user from a number of users and to effect an authentication procedure requiring input from the user before forwarding the data elements.

The invention also provides a computer program containing instructions which when executed cause a computing device (“the second device”) to:

a) receive from a remote computing device (“the third device”) an instruction identifying the network address of a further remote computing device (“the first device”);

b) issue a request for data to the first device, wherein the request including an identification of one or more pre-defined data elements for which the request is made; and

c) receive from the first device one or more of the identified data items.

In the examples mentioned above, this latter program will be the one which runs on the web server, enabling it to direct data requests to the data server.

This program may cause the second device to forward the data items received from the data server to the user, and await confirmation that the data items are valid.

The invention provides yet a further computer program containing instructions which when executed cause a computing device to:

a) receive as an input a network address of a remote computing device;

b) forward to the network address a request for data relating to an identified user;

c) receive from the remote computing device data relating to the user; and

d) utilise the data in a transaction with the user.

This type of program could be run on a hotel PC or the call centre computer system of a telephone ticket seller. The network address could be input manually, or using an ID card held by the user. Alternatively, it could be sent by the user to a call centre using DTMF tones on from a telephone keypad. Yet again it could be sent from a mobile phone or PDA in proximity to the system operating with electromagnetic radiation (e.g. Bluetooth technology).

The invention provides, in a further aspect, a method of obtaining data from a user of a web site, the method including: providing a web page which includes a request for data relating to the user, in which the request includes a machine readable identification of one or more data items required to complete the transaction. The web server then receives from the user one or more of the data items thus identified, such that a data processing device associated with the user can provide the requested data items from a stored file containing data relating to the user organised by data item identifiers.

The invention also provides an information transfer system having:

a) a communications network;

b) first and second data processing devices connected to the network;

c) a storage unit associated with the first device and containing a number of data items relating to a user, in which the data items are organised by data item identifiers;

d) a computer program associated with the first device which causes the first device to

i) determine from a request received from the second device an identification of one or more data items for which the request has been made;

ii) retrieve available data items from the storage unit; and

iii) transmit the data items to the second unit.

The information transfer system may also include a third data processing device connecting the user to the network, and a computer program associated with the second device which causes the second device to:

a) receive an instruction from the third device identifying the network address of the first device, and

b) transmit the request to the first device upon receipt of the instruction.

The invention also provides a web site including a web page containing a request for data relating to a user of the web site, in which the web page includes a machine readable identification of one or more pre-defined data items included in the request.

The invention provides, in addition, a web site hosted by a web server on a data network, the web site including a web page containing a request for data relating to a user of the web site, in which the web page includes an option selectable by a user to cause the web server to direct a request for data to a remote computer identifiable by the user.

### BRIEF DESCRIPTION OF DRAWINGS

The invention will now be illustrated by the following descriptions of embodiments thereof given by way of example only with reference to the accompanying drawings, in which:

FIG. 1 is a simplified architecture of the system of the invention;

FIG. 2 is a web page containing a form for the submission of data items by a user;

FIG. 3 is a flow chart detailing the operation of an embodiment of the invention

FIG. 4 is the web page of FIG. 2 in which the data items relating to the user have been entered according to the invention;

FIG. 5 is a more detailed flow chart of the verification process used in the flow chart of FIG. 3; and

FIG. 6 is a flow chart detailing the operation of a further embodiment of the invention.

### DETAILED DESCRIPTION OF PREFERRED EMBODIMENTS

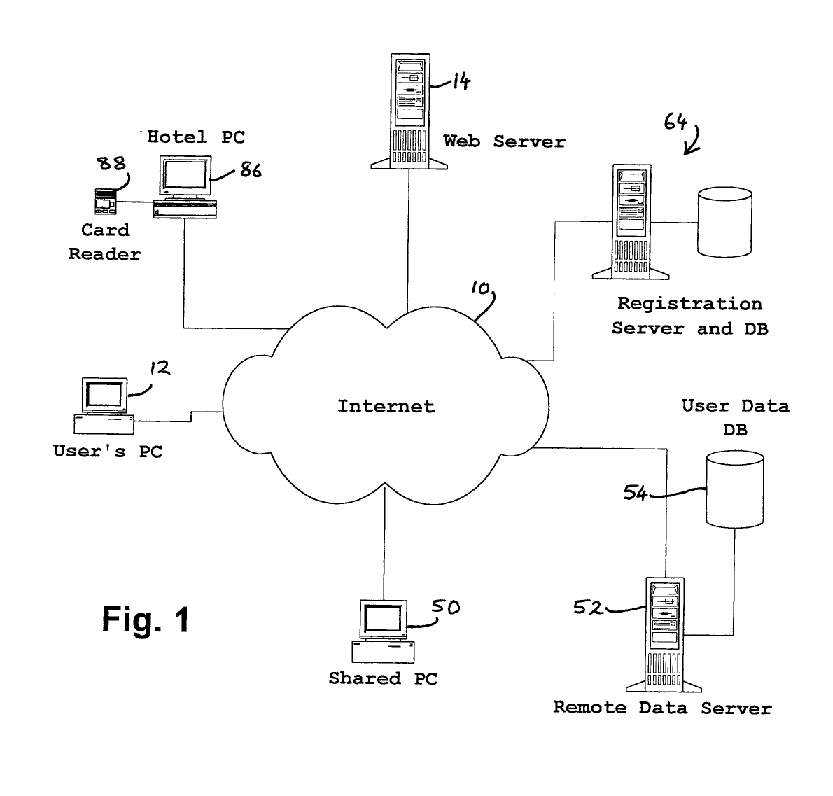

FIG. 1 shows a data network, more particularly the Internet 10 having a number of computers 12, 14, 50, 52, 64, 86 connected thereto, the functions of each being described further below.

A user at a PC 12 runs browser software to access a web site hosted by a server 14. The operation of such browsers to access remotely hosted web pages on the World Wide Web via the Internet is of course well known.

For the purposes of the following discussion it is assumed that the web site accessed by the user is the commercial web site of an airline conducting web-based ticket sales. However, this is exemplary only and a wide range of connected devices over as data network can take advantage of the invention as will be become fully clear.

Users of the web site are typically required to enter the following personal details before a transaction can be processed: Last Name, First Name, Street Address 1, Street Address 2, Town/City, Zip Code, State/Country, e-mail Address and Telephone Number. They are also required to enter the following financial information: Credit Card Number, Credit Card Type, Credit Card Expiry Date, and Name Appearing on Credit Card. Users must of course also enter details of the dates, times and airports for the flights requested.

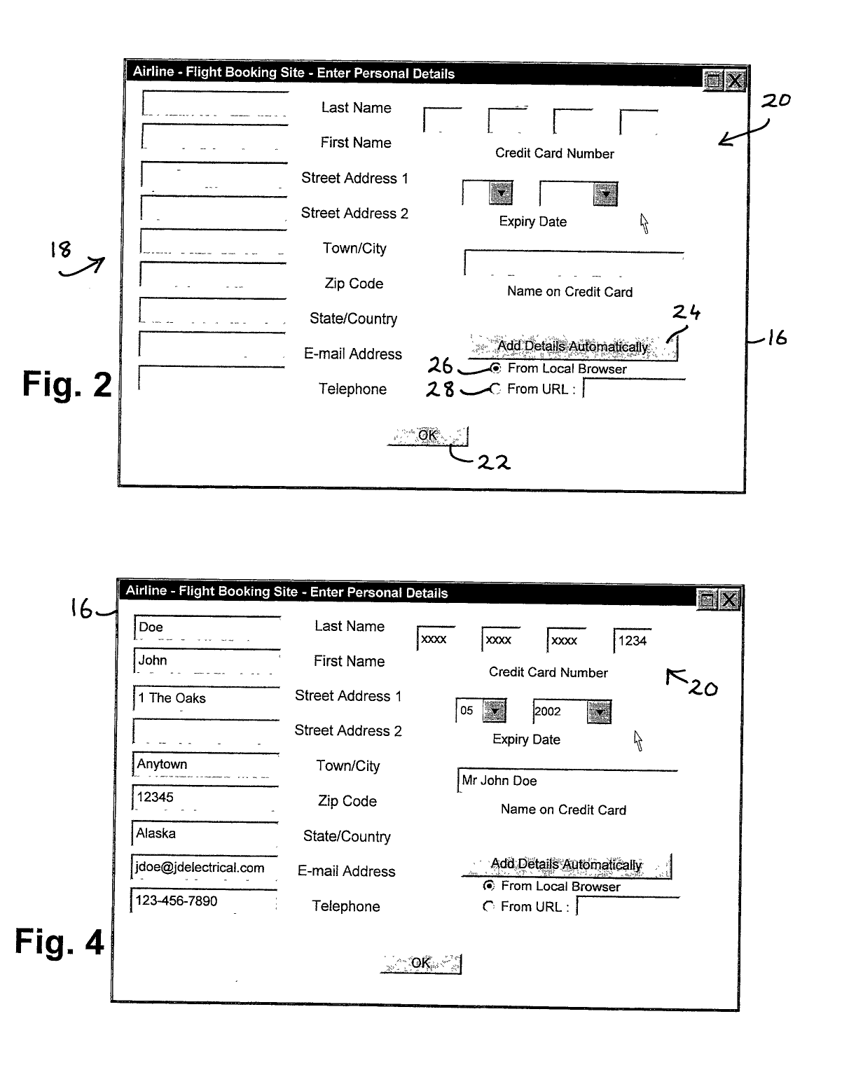

A web page or form 16 requiring the input of this information is shown in simplified format in FIG. 2. The “personal details” referred to above are indicated generally at 18 on the left of the page, and the “financial details” are indicated generally at 20 on the upper right of the page.

A user would normally enter the required information in sections 18 and 20 of the form 16, before pressing the “OK” button 22 to submit the data to the web server 14. However, it can be seen that the web page 16 provides a further alternative, namely the option to “Add Details Automatically”, indicated by button 24.

This option has two sub-options associated with it, namely to add details from the user's local browser, (option 26) or to add details from a remote server (option 28). In the present instance the user is at his or her own PC, and so the option 26 of adding from the local browser will be described first.

The user's browser has additional functionality which embodies the invention. Upon installation of the browser (or at any later time, using the “set-up” program to customise the browser), the user is presented with the option to store commonly requested details (or “data items”), such as those requested in the fields of web page 12. The browser then stores these data items in a user details file, with the various data items tagged by means of a set of standard identifiers. Such a details file might read as follows:

<File Start>
<Tag_Namefield1> <John>
<Tag_Namefield2> <Doe>
<Tag_ShipToAddressfield1> <1 The Oaks>
<Tag_ShipToAddressfield2> <>
<Tag_ShipToAddressfield3> <Anytown>
<Tag_ShipToAddressfield4> <Alaska
<Tag_ShipToAddressfieldzip> <12345>
<Tag_BillToAddressfield1> <JohnD Electrical>
<Tag_BillToAddressfield2> <100 High Street
<Tag_BillToAddressfield3> <Anytown>
<Tag_BillToAddressfield4> <Alaska>
<Tag_BillToAddressfieldzip> <12356>
<Tag_EmailAddressfield1><jdoe@jdelectrical.com>
<Tag_workphone> <123 456 7890>
<Tag_Homephone> <123 456 1234>
<Tag_CreditCard> <1234 1234 1234 1234>
<Tag_CreditCardExp> <0502>
<Tag_MiscInfo1> <Social Security number 12345567>
<Tag_MiscInfo2>
<Tag_MiscInfo3>
<File End>

The file format here is based on an XML or HTML style of associating tags with data, but the invention is by no means limited to such file types. The data will in practice be stored in encrypted form so that third parties who might gain access to the computer will not be able to access the details without a password, for example.

Other details could equally be stored, and in practice, the invention will be enhanced by having a wider range of data items than those listed above. Additionally one could store more than one user profile on a machine, so each member of a family, for example, might have a personal file, or a user might have a personal file and a business file.

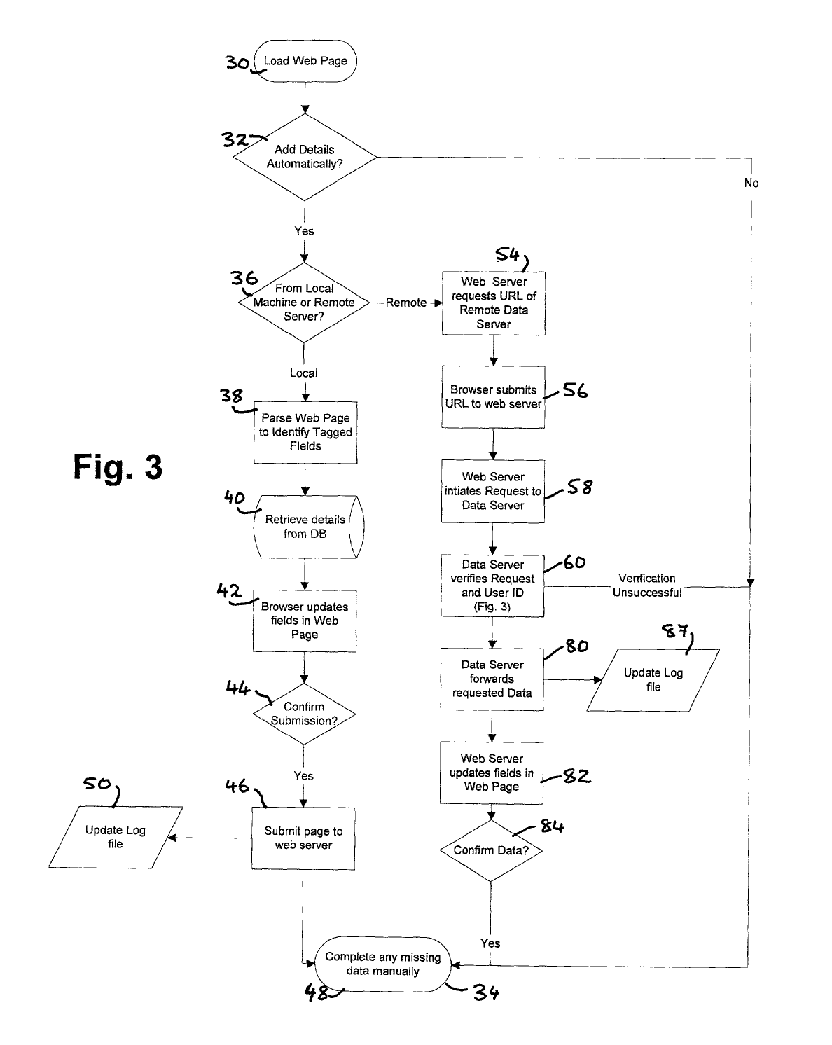

Referring now to FIG. 3, one can see the steps followed by a user visiting the web site. The page is loaded into the user's browser in the normal way, step 30. If the user decides at step 32 to complete the fields manually, the ensuing procedure is exactly as in known web site interactions, step 34. However, if the user chooses the option to add details automatically in step 32, and decides to do so from the local browser, step 36, the browser parses the HTML file (or other file) underlying the web page, step 38, to determine the existence of pre-defined tags identifying standard information to be inserted into some or all of the data fields.

In this regard, the HTML code of the web page is modified relative to conventional HTML code by the addition of identifier tags in the page which identify the data items (e.g. first name, credit card number, etc.) which are required to correctly fill the form on the page. These tags (the format of which will be determined in advance) are interpreted by the browser engine to cause the engine to open the details file and retrieve therefrom the data items contained in the details file for which tags have been included in the HTML file. It is of course possible that the details file will not include all of the requested details (e.g. if the user does not want to store a credit card number on his or her PC). However, those data items which have been requested are retrieved from the details file or database step 40.

The browser then inserts the data items into the blank fields in the web page visible to the user, step 42, as shown in FIG. 4. In accordance with common practice, some or all of the credit card number may not be displayed in section 20, although in this case the user can see the final four digits to ensure that the correct card number will be debited.

The user then has the option to confirm, step 44, that the data is correct by choosing the “OK” button 22. The web page is submitted in the same manner as if the fields had been filled in manually, step 46, including the use of encryption or secure connections to protect privacy. If any of the fields are mandatory and have not been filled in by the browser, the user may correct this before submitting the form, or in response to an error message, step 48. In order to keep track of the identity of the web sites which have received the data items, the user's browser also maintains a log file which is updated, step 50 with each submission of data by the browser from the user's details file.

The log file also enables the browser to update the personal details held by any site previously visited in the event that the user changes e.g. credit card number or address. This can be done in the background immediately after the user updates the details file in response to any changes in circumstances, or it can be done on the next visit to the site. The user can opt to be notified of any such updates to details held by web sites, since the user may not necessarily want the web sites to obtain updated credit card details unless conducting a transaction on the site.

While the process has been described above in relation to a conventional PC connected to the Internet, the same process could be used by any data processing device on a data network having the capability of storing data items with identifiers. Thus, for example, mobile phones and PDAs with the requisite memory and processing power could equally be used to provide a user's personal details to a remote machine.

In an alternative implementation of the invention the user need not submit details held on the browser of the user's computer. For example, the user may wish to register with or conduct a transaction with a web site when away from his or her own PC. As an example, a user might access the web site from a shared computer on a network, which does not contain a details file for the user in question, or from a PC located in a so-called “Internet cafe” where users obtain access from a machine 50 (FIG. 1) which they may never have previously used.

In such cases, the user has the option of directing the web site to obtain the relevant data from a remote data server 52 to which the user's details have been previously submitted. The data server will typically store the details of a large number of users on a dedicated database 54.

The user pre-registers with the data server and fills in the data requested by the data server in much the same way as described above in registering details with the browser loaded on a user's PC, although the pre-registration with the remote data server 52 will generally be done over a secure Internet connection.

The owner of the remote data server may charge a fee or receive some other benefit in return for storing the user's data and dealing with requests as described below.

If the user opts to “Add Details Automatically” in step 32 (FIG. 3) and selects the option to employ a remote server, step 54, the network address of the remote server will be filled in by the user, in the space provided for this purpose in the web page at 28. The user is prompted to enter a network address in the form of a Uniform Resource Locator or URL, which is a web address of the format www.[data server name].com (or .net, .org, .co.uk, etc.).

The URL entered by the user may include a particular file location which gives the remote data server the identity of the user whose details are requested. Thus each account holder might enter a personalised URL such as www.[data server name].com/johndoe. The URL is submitted by the user's browser, step 56, to the web server 14 when the user clicks the button to add details from a remote server.

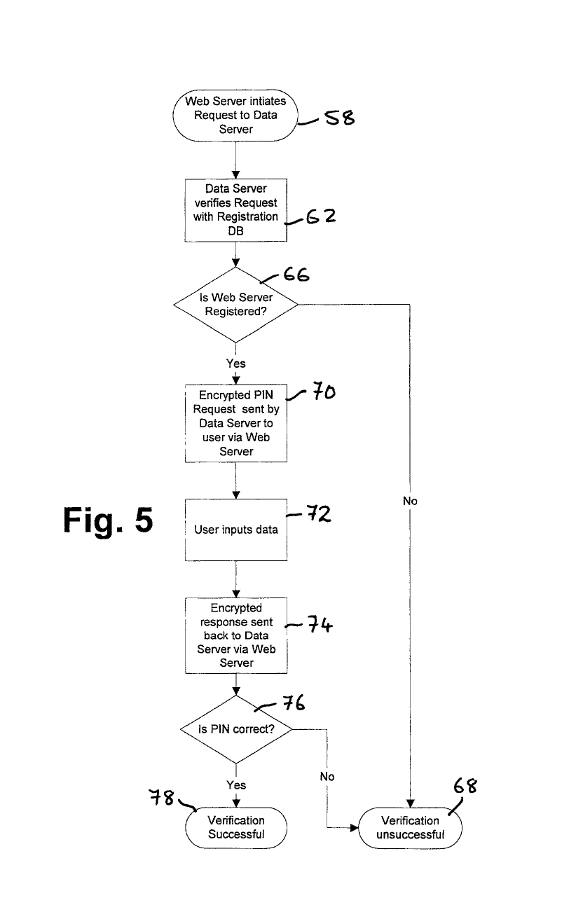

The web server then forwards a request for the user's data to the URL, step 58, identifying the user either by the URL itself, as described above, or by means of a username obtained from the user. As a security measure, the data server may verify, step 60 that the web site is a trusted site, and may also require the user to confirm that the data should be sent to the web site by means of an independent verification described in FIG. 5.

Upon receiving the request the data server consults a registration database, step 62, to ensure that the requesting site is a “trusted” site, according to whatever criteria appear to be appropriate in view of the requested information. This registration database is held on a registration server, together shown in FIG. 1 as 64, and may be maintained by a registration organisation, although equally it could be maintained locally on the data server 54 itself.

If the site does not meet the verification criteria, then decision box 66 leads to an unsuccessful determination 68.

If the site is trusted, then the data server sends to the web site an encrypted PIN request, step 70. This encrypted request is passed in encrypted form to the shared PC 50 (FIG. 1), where it is deciphered. The user enters a PIN or verifies his or her identity in some other way, step 72, and this encrypted response is sent, step 74, via the web server to the data server. The data server verifies that the PIN is correct, step 76 and arrives at either an unsuccessful determination 68 or a successful determination 78.

The user verification could be carried out in another way, such as by the user opening a new browser window, connecting to the data server, and sending a PIN directly to the data server without the involvement of the web site in handling the PIN request.

Alternatively, the user might be sent an email or an SMS text message to a mobile phone whose number is already known to the data server. The data server awaits a suitable response from the user before deciding on a successful determination and reaches an unsuccessful determination if a time-out period is exceeded without a valid user response being received.

Referring back to FIG. 3, if the verification is unsuccessful in step 60, the user must complete the fields manually, step 34. However, if there is a successful determination, the data server 52 accesses the details database 54 and retrieves the requested data items which are again identified from the request of the web site. It may be the case that the request is for all user data stored in respect of the user, or for particular groups of data items (e.g. if there is no financial transaction, the request might simply be in respect of name, address and e-mail address). Different web sites might be registered to obtain different levels of detail regarding the user.

The data server forwards a file containing the data items, step 80, and the web server inserts the data items in the corresponding fields, step 82, and presents the form with the data items to the user at the shared PC (FIG. 4), following which the user can edit and confirm the data in step 84. Again, the user is presented with the opportunity to manually complete any missing mandatory data fields in step 86, and the data server maintains and updates a log file, step 87, recording the transfer of information to the web site.

The invention can also be implemented when the user needs to provide details such as personal and/or financial details to a third party for a computer application, even if the user is not directly accessing a computer on a data network such as the Internet. An example of this is when checking into a hotel, which has a PC 86 connected to the Internet (FIG. 1) running a check-in application.

The user wishing to check into the hotel provides the hotel PC 86 with information sufficient to enable that PC to make a data request to the data server in similar manner to that described for a user on a shared PC.

The invention can be implemented by the user carrying an ID device which may have the appropriate URL printed thereon, or preferably, stored thereon in machine readable format. Examples of such devices include magnetically readable data carriers, such as cards bearing a magnetic strip, optically readable data carriers, such as CD-type business cards, carriers containing an integrated circuit on which an identification is stored, such as so-called smart cards having an embedded chip, and devices operable to transmit electromagnetic signals to an ID device reader, such as mobile phones or other wireless devices communicating by means of Bluetooth technology. Other devices could also be used, including mechanically readable data carriers.

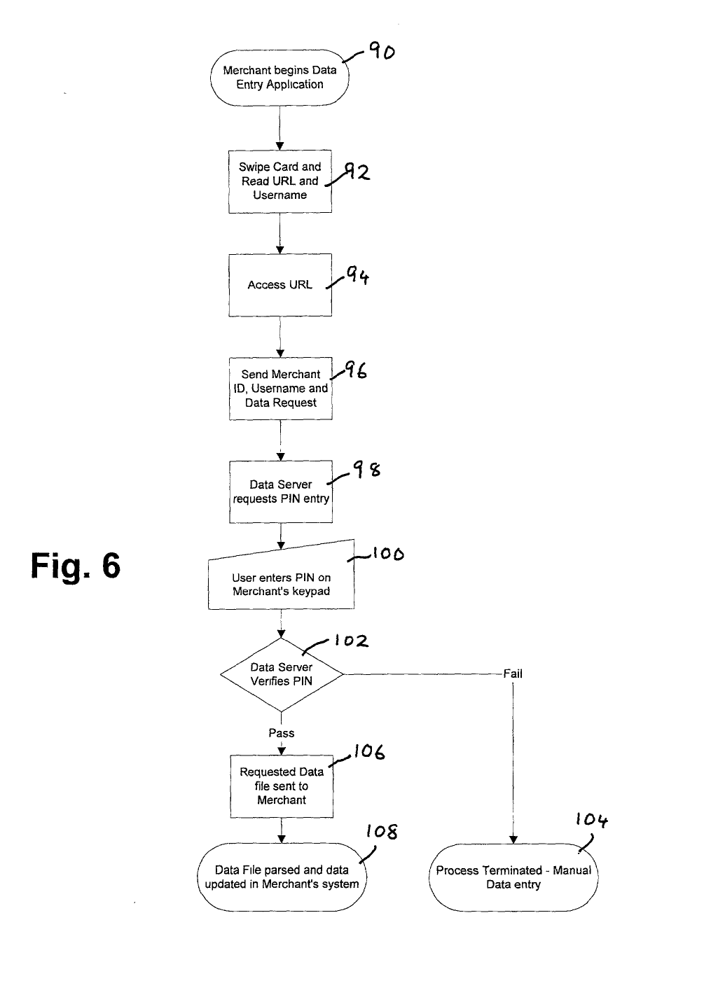

In the embodiment of FIG. 1, the hotel PC 86 has an associated magnetic card reader 88 which can read a magnetic strip encoding the URL and user ID of the user wishing to check in. The hotel PC runs the data entry application (check-in system), step 90, FIG. 6. The user swipes his or her magnetic card in the card reader 88, enabling the PC 86 to read the URL and user ID.

The PC then accesses the URL, step 94, and requests the data items necessary for the check-in process to be automated as far as possible. With the request, step 96, the PC sends an identification of the organisation requesting the information (merchant ID) and the user ID or username of the user whose details have been pre-registered with the data server, as previously described.

The data server can then optionally conduct a verification of the merchant ID as described above in relation to a web site verification, and the PC then, on behalf of the data server, requests a user PIN entry, step 98. This PIN entry can be input on a keypad included in the card reader, step 100 (although other means can be included for the user to verify that the data request should be answered, such as using SMS messaging, as previously described).

The data server then decides whether the PIN verification has passed or failed in decision box 102. If the result is a fail, the user can complete the check-in process in the conventional way, step 104. Otherwise, step 106, the requested data items are retrieved from the user's details file in the database 54, and sent to the merchant's PC. The data file retrieved by the hotel PC is parsed and the retrieved data items are entered by the hotel PC in the check-in system, step 108.

Although described in relation to a hotel check-in procedure, a similar system can also be used for airline reservations and check-ins, or for any of a wide range of commercial transactions or other interactions in which it is necessary for a person or organisation to pass details to another person or organisation. Particular examples include the passing of data needed to complete transactions over the telephone, such as when buying tickets, or registering for competitions. In such cases, a user could read out a URL, or a number corresponding to an Internet address to an operator. For example, URLs are resolved by domain name servers into Internet network addresses which may be of the form 123.456.78.9 (with, in most cases at present, a maximum of three digits in each field separated by periods). Any such address can be uniquely quoted as a 12 digit number using leading zeroes, e.g. 123456078009, thereby directing the merchant to a website containing all of the user's relevant details. The user might also quote a personal ID number.

Alternatively, the relevant numbers could be input to a telephone handset by pressing the digits in question, which would be transmitted as DTMF tones and automatically processed by an Interactive Voice Response system. While less complicated than a simple card swipe, the use of such technology to pass details to a third party is still less prone to error and less time consuming than a user having to dictate, and an operator having to transcribe, the numerous details which may be required even for a simple transaction, particularly if there are language barriers or misunderstandings.

The invention is not limited to the embodiments described herein which may be varied without departing from the spirit of the invention.

What is claimed is:

1. A method of transferring data relating to a user from a first data processing device to a second data processing device over a communications network, said method comprising the steps of:
a) said first device receiving over said network from said second device a request for said data, said request including an identification of one or more pre-defined data elements for which the request is made;
b) said first device accessing a file containing data relating to the user, said file including data elements identified by data element identifiers and retrieving from said file one or more of said data elements identified in said request; and
c) said first device forwarding to said second device said retrieved data elements.

2. A method according to claim 1 wherein one or both of said devices are computers.

3. A method according to claim 1, wherein said file is stored on said first device.

4. A method according to claim 1, wherein said request is in the form of a web page having one or more fields for receiving data elements, and wherein said identification of one or more pre-defined data elements is in the form of a machine-readable tag accompanying said one or more fields.

5. A method according to claim 4, wherein said first device retrieves from said data file those data elements having identifiers which correspond to the tags in the request.

6. A method according to claim 5, wherein a browser engine operating on said first device adds said retrieved data elements to said web page and presents the web page including the added data elements to a user before forwarding said data elements to said second device.

7. A method according to claim 6, wherein said browser engine provides the user with the option to confirm the submission of said data elements before forwarding said data elements to said second device.

8. A method according to claim 6, wherein said browser engine provides the user with the option to vary said data elements before forwarding said data elements to said second device.

9. A method according to claim 1, further comprising the step of said first device logging the submission of said data elements to said second device.

10. A method according to claim 1, wherein said first device is a server which stores said data on behalf of said user.

11. A method according to claim 10, further comprising the step of verifying with said user that the data should be forwarded to said second device.

12. A method according to claim 11, wherein said user is connected to said network by a device which is physically remote from said first device.

13. A method according to claim 12, wherein said user is connected to said network by a third data processing device.

14. A method according to claim 13, wherein said user uses said third device to access a web page hosted by said second device, and wherein the user directs said second device to forward said data request to said first device in order to supply information requested on said web page.

15. A method according to claim 14, wherein said user provides said second device with the network address of said first device.

16. A method according to claim 12, wherein said first device generates a verification request to said user in response to the data request being received from said second device.

17. A method according to claim 16, wherein said user is connected to said network by a third data processing device.

18. A method according to claim 17, wherein said verification request is passed from said first device to said third device via the second device.

19. A method according to claim 16, wherein said user is based at said second device and wherein the verification is accomplished by means of an interaction between said user and said second device.

20. A method according to claim 19, wherein said user interacts with said second device at least partially by means of an ID device held by the user and an ID device reader connected to said second device.

21. A method according to claim 20, wherein said ID device is selected from a magnetically readable data carrier, an optically readable data carrier, a carrier containing an integrated circuit on which an identification is stored, a device operable to transmit electromagnetic signals to an ID device reader, and a mechanically readable data carrier.

22. A method according to claim 20, wherein said ID device carries a network address of said first device in machine readable format.

23. A method according to claim 20, wherein said ID device carries a network address of said first device in human readable format.

24. A method according to claim 20, wherein said ID carrier contains information effective to identify the user to the first machine.

25. A computer program product in machine readable form containing instructions which when executed cause a computing device to transfer data relating to a user over a communications network by:
a) receiving over said network a request for said data, said request including an identification of one or more pre-defined data elements for which the request is made;
b) accessing a file containing data relating to the user, said file including data elements identified by data element identifiers and retrieving from said file one or more of said data elements identified in said request; and
c) forwarding over said data network to another computing device said retrieved data elements.

26. A computer program product according to claim 25, further comprising instructions to implement a web browser.

27. A computer program product according to claim 26, wherein said request is in the form of a web page having data entry fields and wherein said browser identifies the data elements required for said fields from tags included in the web page.

28. A computer program product according to claim 27, wherein said browser is effective to fill the retrieved data into the corresponding data fields in the web page and to present said web page including said data to said user.

29. A computer program product according to claim 25, wherein said instructions are further effective to cause the computing device to identify said user from a plurality of users and to effect an authentication procedure requiring input from said user before forwarding said data elements.

30. A computer program product in machine readable form containing instructions which when executed cause a computing device (“the second device”) to:
a) receive from a remote computing device (“the third device”) an instruction identifying the network address of a further remote computing device (“the first device”);
b) issue a request for data to said first device, wherein said request includes an identification of one or more pre-defined data elements for which the request is made; and
c) receive from said first device one or more of said identified data items.

31. A computer program product according to claim 30, further effective to cause said second device to forward said data items received from said first device to said third device, and await confirmation that said data items are valid.

32. A computer program product in machine readable form containing instructions which when executed cause a computing device to:
a) receive as an input a network address of a remote computing device;
b) forward to said network address a request for data relating to an identified user;
c) receive from said remote computing device data relating to the user; and
d) utilise said data in a transaction with the user.

33. A computer program product according to claim 32, wherein said network address is input by means of a reading device reading said address from an ID device held by said user.

34. A computer program product according to claim 32, wherein said computing device is selected from a hotel check-in terminal, an airline check-in terminal, and a call centre to which the user has a telephony connection.

35. A method of obtaining data from a user of a web site, the method comprising providing a web page which includes a request for data relating to the user, wherein said request includes a machine readable identification of one or more data items required to complete the transaction, and receiving from the user one or more of the data items thus identified, whereby a data processing device associated with the user can provide the requested data items from a stored file containing data relating to the user organised by data item identifiers.

36. An information transfer system comprising:
a) a communications network;
b) first and second data processing devices connected to said network;
c) a storage unit associated with the first device and containing a plurality of data items relating to a user, in which said data items are organised by data item identifiers;
d) computer program means associated with the first device which when executed cause the first device to
i) determine from a request received from said second device an identification of one or more data items for which the request has been made;
ii) retrieve available data items from said storage unit and
iii) transmit said data items to said second unit.

37. An information transfer system according to claim 36, further comprising a third data processing device connecting said user to said network, and computer program means associated with said second device which when executed causes said second device to:
a) receive an instruction from said third device identifying the network address of the first device, and
b) transmit said request to said first device upon receipt of said instruction.

38. An information transfer system according to claim 37, wherein said computer program means associated with said second device further causes said second device to forward said data items received from said first device to said third device, whereby said user may issue from said third device to said second device a confirmation signal that the data items are correct.

39. A web site including a web page containing a request for data relating to a user of the web site, wherein said web page includes a machine readable identification of one or more pre-defined data items included in said request.

40. A web site hosted by a web server on a data network, said web site including a web page containing a request for data relating to a user of the web site, wherein said web page includes an option selectable by a user to cause the web server hosting the page to direct a request for data to a remote computer identifiable by said user.
